(19) United States
(12) Patent Application Publication
(10) Pub. No.: US 2008/0165472 A1
(43) Pub. Date: Jul. 10, 2008

(54) High dielectric composites as capacitive materials

(76) Inventors: Liang-Chy Chien, Hudson, OH (US); Andrii B. Golovin, Kent, OH (US)

Correspondence Address: HUDAK, SHUNK & FARINE, CO., L.P.A., 2020 FRONT STREET, SUITE 307, CUYAHOGA FALLS, OH, 44221, US

(21) Appl. No.: 12/001,859

(22) Filed: Dec. 13, 2007

Related U.S. Application Data
(60) Provisional application No. 60/875,800, filed on Dec. 19, 2006.

(51) Int. Cl. H01G 9/035; H01G 9/00

(52) U.S. Cl. 361/504; 29/25.03

(57) ABSTRACT

Novel electrolytic capacitors are based on a composite liquid crystal electrolyte sandwiched between two electrodes where the electrolyte comprises a dispersion of a lyotropic liquid crystal in a dispersion media, and where the liquid crystal is a chromonic liquid crystal and the dispersion media is selected from a variety of materials ranging from liquids to solid polymers. Further the electrolyte optimally including a surfactant or surfactant system selected so as to influence the charge characteristics of the capacitor. The capacitors provide relatively high capacitance in a relatively thin device; are insensitive to reversal of polarity of an applied bias voltage; and can be produced at selected charging and discharging frequencies which in turn influences the characteristics of release of stored power. The invention further relates to methods of making the capacitors which utilize low cost materials and low cost fabrication techniques.

### CROSS-REFERENCE

This is a U.S. patent application of U.S. Provisional Application No. 60/875,800 filed on Dec. 19, 2006 for COMPLEX FLUID BASED ELECTROLYTIC CAPACITORS which is hereby fully incorporated by reference.

### FIELD OF THE INVENTION

The present invention relates to novel electrolytic capacitors based on a complex liquid crystal electrolyte sandwiched between two electrodes. This electrolyte comprises a composite (i.e., any mixture) which is a dispersion of a lyotropic liquid crystal in a dispersion media, where the liquid crystal is a chromonic liquid crystal and the dispersion media is selected from a variety of materials ranging from liquids to solid polymers and the electrolyte optimally including a surfactant or surfactant system selected so as to influence the charge characteristics of the capacitor. The capacitors provide relatively high capacitance in a relatively thin device; are insensitive to reversal of polarity of an applied bias voltage; and can be produced at selected charging and discharging frequencies which in turn influences the characteristics of release of stored power. The invention further relates to methods of making the capacitors which utilize low cost materials and low cost fabrication techniques.

### BACKGROUND OF THE INVENTION

There have been ongoing demand for ever smaller electrical components to support the continual drive to small mobile electronic devices ranging from mobile phones to notebook computers. High temperature and high energy density capacitors are of interest for applications which include pulse-power capacitors and high density capacitors for high power electronics which can be discharged quickly without large losses, so as to be able to use electrical power to propel mechanical vehicles and fire weapons. There are also many civilian applications in which large peak power is required immediately, while also requiring a more gradual draw of lower power. In addition, there are a large number of applications in which capacitance in small light-weight portable devices are of interest.

Electrical energy storage devices have the potential to increase their capabilities through the use of custom engineered materials in the storage element. Specific items of interest for improvement are the energy storage density, cycle lifetime, and reliability of these devices. Thus a goal is a significant improvement of the ability of distributed energy systems to meet the needs of the modern day grid. It is of particular interest in these energy storage devices to provide electrolytic capacitors which have a high energy density despite a small size, such that they can be widely used in a frequency filter. Capacitors of this type fabricated so as to manifest a large energy density (i.e., high energy per unit volume) at intermediate use voltages (10˜300V) are exemplified in numerous applications. Electrolytic capacitors generally have a structure comprising an anode foil and a cathode foil intermediated by a separator spirally wound together and placed and sealed in a casing. As an anode foil, a valve metal such as aluminum or tantalum, having an insulating oxide film as a dielectric layer is generally used. An etched aluminum foil can be used as cathode foil. To prevent short-circuiting between the electrodes, the separator disposed there between is impregnated with an electrolyte, and it functions as a true cathode.

The electrolyte is an important constituent which substantially affects the properties of the electrolytic capacitor such as the energy loss and impedance properties of the electrolytic capacitor. High dielectric electrolytes have been prepared utilizing aqueous solutions of ethylene glycol with ionogens such as acetic acid, phosphoric acid and ammonium acetate. Dielectric breakdown is one of the principal characteristics for evaluating the performance of high power and high temperature capacitors. Since the energy density has a square dependence on the dielectric breakdown voltage and varies linearly with the dielectric constant; enhanced breakdown strength is critical to the performance of a capacitor. However, working electrolytes of this type have high electric conductivity and a low breakdown voltage so as to cause premature failure during operation. In addition, while these capacitors have historically fulfilled many of the necessary requirements, electrolytes containing ethylene glycol are not as thermally (at high temperatures, i.e. above 100° C. ) and electrically stable (polarization dependent) as desired .

The inadequacy of commercial off the shelf capacitors in meeting the challenges of high voltage and high temperature make it an imperative to design next generation dielectric materials for the development of high-energy density storage useful for a variety of energy delivery systems. To solve the above problem of high voltage, high temperature and pulse-power driven applications there is a need to design next generation high energy density capacitors based on high dielectric soft composite materials. Traditionally, capacitors are built by the lamination of an electrolyte in between two electrodes; an anode and a cathode. The anode is made of a regular metal such as aluminum, tantalum or niobium, on the surface of which a dielectric or insulating oxide film layer is formed by anodization or some other means. An electrolytic capacitor is a type of capacitor having a large capacitance per unit volume P. McK. Deeley, Electrolytic Capacitors (Cornell-Dubilier, South Plainfield, N.J., 1938). Compared with bulk dielectric capacitors, this very thin layer of high dielectric liquid enables more capacitance in the same unit volume. The liquid electrolyte is in contact with the dielectric oxide film layer and serves as the true cathode. The choice of liquid electrolyte determines the performance characteristics of the electrolytic capacitor. Traditionally the electrolyte is sodium borate in water with addition of ethylene glycol to reduce evaporation. Charging the capacitor is accomplished by applying a voltage to an electrolytic capacitor. However, electrolytic capacitors have a polarity, so they can be reverse biased just up to the point that the liquid heats up and the capacitor is destroyed. Therefore, the characteristics such as the specific resistance of the liquid electrolyte have direct effects on the electrical characteristics of the electrolytic capacitor.

In general, the electrolyte is one of the key components in broadening operational temperature ranges without sacrificing the storage/cycle life and power performance of the capacitor at elevated temperatures (i.e., above about 100° C.). The electrolyte also impacts the safety of the capacitor. Electrolytic capacitors are suitable for high-current and low-frequency electrical circuits and energy storage. They are also widely used as coupling capacitors in circuits where AC should be conducted while DC should be not. Therefore, the development of a conductive electrolyte is critical for achieving high power density and high density energy storage for pulse power sources and portable electronics. There is a necessity for these new electrolytes to be independent of polarity for the electrolytic capacitors.

Liquid crystals (LCs) are a fascinating phase of matter that possess optical and dielectric anisotropic properties and promise applications as polarizing optical films and biosensors and which could bring unique properties to bear in the manufacture of electrolytic capacitors. While there are different types of liquid crystals, in one type, the liquid crystal phase is dependent on the concentration of one component relative to the other; this type of liquid crystal is called lyotropic liquid crystal. The family of liquid crystals has been dramatically expanded to those solution based self-assemblies of lyotropic liquid crystals from thermotropic molecules which optically respond to electric field-induced reorientation on which the LCD industry is based. Among the class of lyotropic liquid crystals, lyotropic chromonic liquid crystals (LCLCs) represent a versatile class of new materials which comprise a range of drug, antibiotic and dye molecules. The flake-shaped LCLC molecules consist of a rigid core and polar groups that are drastically differently from that of amphiphilic molecules. The ionic polar groups provide ionic polarization and enable the generation of a large dielectric constant. The LCLC molecules may be more disc-like or brick-like than rod-like in shape with the hydrophilic functional groups located at the edge of molecule, while the central core is relatively hydrophobic. This distinct feature creates a whole new range of ordered structures. In addition, the intrinsic ionic properties of these LCLC represent a new class of high dielectric materials.

A microemulsion is a thermodynamically stable phase, consisting of oil, water and surfactants. Their structure can be dispersed micelles of one fluid in another continuous fluid. Emulsions, i.e. mixtures of two immiscible liquids together with a surfactant may form both macroemulsions and microemulsions and in which the two immiscible fluids are isotropic, have been studied extensively (see Tiddy, G. J. T., Masteer, D. L. Ormerod, A. P., Harrison, W. J., Edwards, D. J., “Thermotropic and Lyotropic Mesophase Behavior of Amphitropic Diammonium Surfactants, Langmuir 12, 1117 (1996) and Sjoblom, J. ed., “Emulsions and Emulsion Stability, Marcel Dekker, New York (1996) Such mixtures are typically prepared mechanically, and are not in thermal equilibrium. As far as the exchange of molecules is concerned, this may happen because there are droplets of one phase in the other but material in both phases can be exchanged between the droplets on the time scales of interest, or because both phases are continuous. There has been considerable work on macroemulsions consisting of droplets of thermotropic nematic liquid crystals in isotropic fluids (see Gelart, W. M., Roux, D. and Ben-Shaul, A., “Micelles, Membranes, Microemulsions, and Monolayers,” Springer-Verlag, New York (1994)), nematic droplets dispersed in polymer matrix, and some work on macroemulsions consisting of droplets of isotropic fluids in nematics (see Drzaic, P. S., “Liquid Crystal Dispersions,” World Scientific, Singapore (1995); Poulin, P., Stark, H., Lubensky, T. C., Weotz, D. A., “Novel Colloidal Interactions in Anisotropic Fluids,” Science, 275, 1770 (1997); and Lubensky, T. C., Petty, D., Currier, N., Stark, H., “Topological Defects and Interactions in Nematic Emulsions,” Phys. Rev. E, 57, 610 (1998)). However, there has been rather little work studying the properties of microemulsions consisting of liquid crystals and isotropic fluids. Especially, there is little study on microemulsions and nanoemulsions consisting of lyotropic liquid crystals and isotropic fluids for electrolytic fluids. Such microemulsions are also of considerable scientific interest. These microemulsions are the subject of the present invention, which focuses initially on microemulsions with lyotropic fluids, “LCLC”, and isotropic medium such as low dielectric isotropic fluids, and extends to embodiments using polymers as the dispersing matrix. In this way, the invention may relate to new ornamental applications such as biosensors which are more sensitive and accurate than that of the reported optical detection method using LCLC in which the technique relies on large conglomerates of probe and target to create defects in liquid crystal alignment (see Lubensky, T. C., Petty, D., Currier, N., Stark, H., “Topological Defects and Interactions in Nematic Emulsions,” Phys. Rev. E, 57, 610 (1998) and Woolverton, C. J., gustily, E., Li, L., and Lavrentovich, O. D., “Liquid Crystal Effects on Bacterial Viability,” Liq. Cryst., 32, 417 (2005), Shiyanovskii, S. V., Lavrentovich, *O. D., Schneider, T , Ishikawa, T., Smalyukh, I. I. , Woolverton, C. J., Niehaus, G. D., Doane, K. J., “Lyotropic Chromonic Liquid Crystals for Biological Sensing Applications,” Mol. Cryst. Liq. Cryst., 434, 259 (2005)). Furthermore, LC tunable capacitors have been reported for radio frequency (RF) applications (see (Chiaming Alex Chang, Chih-Cheng Cheng, and J. Andrew Yeh; “Analysis and Modeling of Liquid-Crystal Tunable Capacitors”, IEEE TRANSACTIONS ON ELECTRON DEVICES, VOL. 53, 1675 (2006)). However, the dielectric for thermotropic liquid crystal at this RF range is negligible. Depending on the configuration of the capacitor, the tuning ranges of LC capacitors at 4 GHz from 0 to 5V were found between 7-11% efficiency mainly because of the low dielectric of thermotropic nematic liquid crystal.

### SUMMARY OF THE INVENTION

The present invention provides a method of fabrication of low-cost electrolytic capacitor based on high dielectric complex fluids comprising of a silicon oil, surfactant and lyotropic liquid crystal. This invention also provides an electrolytic capacitor comprising two electrodes, and an electrolytic complex fluid deposited between the electrodes. The disclosed electrolytic complex fluid comprises a lyotropic liquid crystal which is a chromonic liquid crystal, dispersed in a dispersion medium which is selected from a variety of materials ranging from liquid to a solid polymer and optimally including a surfactant which is selected to determine the dispersion characteristics of the liquid crystal in the dispersion media. The surfactant serves as the dispersion agent can be selected from either low or high molecular weight species At least one or combination of several surfactants can be used to form the lyotropic fluid dispersion. One of the unique properties of this type of electrolyte capacitors is polarity independence Furthermore, the composition of the complex fluid electrolyte enables the capacitor to be charged and discharged at a selected frequency region through the choice of the relaxation frequency of the electrolyte, which in accordance with the invention can be determined by tailoring the dispersion characteristics of the liquid crystal in the dispersion media, for example, by determining the micelle size and distribution through the addition of a specific type and quantity of surfactant or surfactant system.

It is likewise an aspect of the present invention to provide a method of making a solid state capacitor comprising the dispersed conductive electrolyte. The energy storage device produces a reduced resistance by the ionic conducting electrolyte, such that the high frequency response characteristic is improved by varying the type or concentration of surfactant for dispersion. Additionally the characteristics are influenced by the material composition and morphology of the dispersion media, such as the size and distribution of the liquid crystal micelles within the dispersion media, which can be set, not only by the selection of the surfactants for example, for liquid dispersion media, but also for solid dispersion media by initiating polymerization (for example using photopolymerization) of a solid state dispersion media (such as a polymer) at temperatures, and under conditions such as to influence the phase distribution and domain characteristics between the liquid crystal and the dispersion media. Polymer systems can be useful in the invention which use any number of types of initiators, including initiators which rely on heat (thermal polymerization), on light or energy at a certain wavelength (photo-polymerization), or which utilize a chemical reaction to initiate polymerization.

### BRIEF DESCRIPTION OF THE DRAWINGS

For a complete understanding of the present invention, reference is made to the following detailed description and accompanying drawings, wherein:

FIG 1 is a representation of a liquid crystal fuel cell in accordance with the invention in which FIG. 1(a) illustrates micelle formation at no applied DC field and FIG. 1(b) illustrates the elongation and alignment of the droplets upon the application of a DC field;

FIG. 2 is a graphical representation of a) dielectric constant and b) relative capacitance as a function of frequency of a silicon fluid;

FIG. 3 is a graphical representation of a) dielectric constant as a function of frequency, b) relative capacitance versus frequency and c) the relaxation frequency of the complex system consisting of 90% silicon fluid and 10% of a lyotropic liquid crystal;

FIG. 4 is a graphical representation of a) dielectric constant as a function of frequency, b) relative capacitance versus frequency and c) the relaxation frequency of the complex system consisting of 90% silicon fluid, 9.95% of a lyotropic liquid crystal and 0.05% of FC4434 fluorinated surfactant;

FIG. 5 is a graphical representation of the epoxy resin, water solution of cromolyn, and surfactant FC4430 (66.85:33:0.15): the dissipation factor vs applied voltage (a), the polarizing optical micrograph of the anisotropic composite showing nematic droplets (b), and the capacitance vs applied voltage of a composite of lyotropic nematic and epoxy composite capacitor(c); and

FIG. 6 is a graphical illustration of the composite of Norland polymer, water solution of cromolyn, and surfactant FC4430 (80:19.8, 0.2): the dielectric permittivity vs frequency (a), the polarizing optical micrograph of the anisotropic composite showing nematic droplets (b), and the capacitance vs applied voltage of the composite (c).

### DETAILED DESCRIPTION OF THE INVENTION

In accordance with a first embodiment of the invention, it has been demonstrated that formation of microemulsion of a lyotropic chromonic liquid crystal, “LCLC” in a low dielectric isotropic liquid crystal enables a substantial increase in the dielectric constant to several orders of magnitude. Compared to the dielectric constant of less than 100 of conventional nematic or ferroelectric liquid crystals, the discovery has led to the present invention relating to the use of the complex fluids as high density capacitors when laminated between conductive substrates with a few microns gap separation. Furthermore, the real part of dielectric constant and dielectric relaxation frequency can be further tuned or tailored to a desired value by the incorporation of a surfactant or surfactant system at a low concentration to form micelles of a particular size or structure In a further embodiment, a second composite system is provided in which the low dielectric oil of the first embodiment is replaced with polymer to form dispersions. As used herein a “composite” refers to any mixture, such as for example, a dispersion, an emulsion or more broadly, a mixture. Finally, it is anticipated that the dielectric constant or electric permittivity can be influenced by the addition of nano additives such as nanotubes, nanowires, nanoparticles and ferroparticles. The dissipation factors as a function of applied voltage of the resultant capacitors have been dramatically improved and the capacitor has been made independent of the bias of the polarity of the applied voltage.

The present invention relies on the dispersion of the lyotropic liquid crystal (LLC) in a dispersion media which is sandwiched between two electrodes. To provide good wetness, the electrodes are coated with a wetting agent such as polyimide layers. Optimally, alignment materials which contain glass fiber or bead spacers are sprayed between the substrates in order to control the gap of the capacitor device. Preferably, the LLC is selected from a chromonic liquid crystal (see, for example, J. E. Lydon, in Handbook of Liquid Crystals, edited by D. Demus, J. Goodby, G. W. Gray, H. -W Spiess, V. Vill, vol. 2B (Willey-VCH, New York, 1998)) and the dispersion media is selected from a wide variety of materials from liquid to solid materials including polymers and optionally including additives which influence the structure and size of the micelles or otherwise influence the dielectric permittivity, such as nanotubes, nanowires nanoparticles and Ferro particles. The LLC and the dispersion media may, for example, be miscible at one temperature, but immiscible at a lower temperature of the LLC and dispersion media because of the opposite physical natures which are water-like and oil-like, respectively. Upon phase separation, the LLC may be the minority and form the discontinuous phase, while the dispersion media is the majority and form the continuous phase. The addition of a non-ionic type surfactant selected from the commercially available products enables the change of domain size of the LLC and possibly influences the micelle structure.

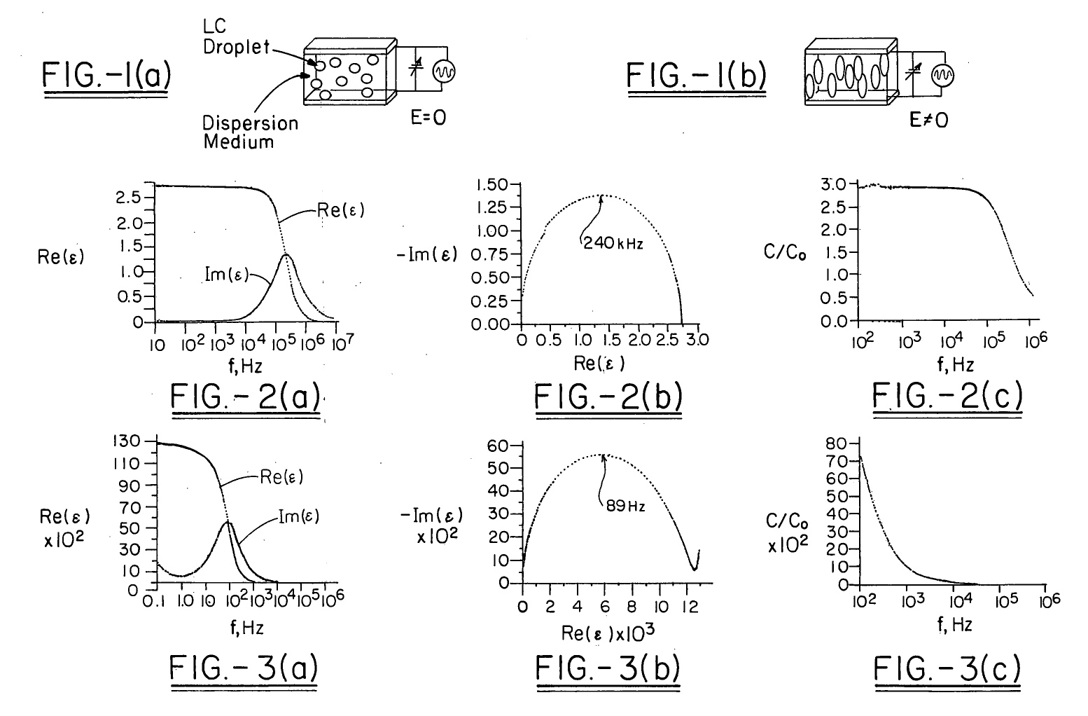

The design of the parallel-plate capacitor is simple and straightforward. To assemble the body of the capacitor 10 as shown in FIGS. 1(a) and 1(b), two glass substrates 12, 14 covered with plane electrodes 16,18 of the Indium Tin Oxide (ITO) were used. The substrates may be replaced with thin plastic films. To provide good wetness of the surfaces, ITO electrodes were covered with polyimide layers. The gap thickness of 5 micron was insured with glass spacers placed between glass substrates. Sides of glass or plastic substrates were glued with epoxy after the capacitor was filled with complex fluid 20. To charge the capacitor, two wires were attached to the ITO electrodes by using an ultrasonic solder. In contrast with electrolytic capacitors, the designed capacitor is polarity independent and shows high capacitance because of dispersed guest droplets and can be adjusted to work in the broad frequency range (0.1 Hz-2 kHz). In the experiments, Hewlett Packard 4284A Precision LCR Meter (20 Hz-1 MHz) and Shlumberger Sl1260 Impedance/Gain- Phase Analyzer were used to charge and measure the capacitor parameters.

In general, the complex electrolyte system of the present invention comprises a dispersion media, surfactant and LLC. The composition may be varied for the purpose of adjusting the dielectric relaxation frequency for charging and discharging the capacitor at a desired rate. The LLC is prepared by dissolving a disk-shaped compound with polar groups, a disodium cromoglycate, at a concentration of 14%(This needs to be a range, i.e. from about 5 to about 40%, and more preferably from about 10 to about 25%, and most preferably from about 10 to about 15%) by weight in water. The disk-shaped cromolyn molecules aggregate and self-assemble into a lyotropic phase The concentration of LLC solution in the complex system may be from 1% to 90% in the dispersion media. Preferably, the concentration may be from 5% to 60% and more preferably, the concentration may be from 10% to 25%. The dispersion media may be selected from a very low dielectric material such as a silicon fluid or polymeric material. A surfactant is served for the purpose of dispersing the conductive electrolyte homogenously in the media. The surfactant is preferably selected from a non-ionic base and may be low or high molecular weight. The concentration of surfactant may be from about 0.01 to about 10%, and preferably from about 0.01 to about 7%, and preferably from about 0.01% to 5%. Complex fluids include polymeric and surfactant solutions as well as colloidal suspensions and biomolecular assemblies. These “soft materials” are distinguished by collective structure on both local and mesoscopic scales, which plays a crucial role in determining their often unique materials properties.

The complex fluid is prepared by mixing a lyotropic ionic conducting electrolyte, surfactant and dispersion media in a container and the container is submerged in an ultrasonic cleaner bath for an hour to ensure good dispersion. The electrolytic fluids are filled in the cells with the cell gap of from about 0.5 to about 25 microns, and preferably from about 1 to about 10 microns, and most preferably about 3 to 7 microns, between plane electrodes which are separated by glass bead spacers. In this case, the conductive electrodes are indium-tin oxide layers with a surface resistance around from about 10 to about 50, and preferably about 25 to about 40, and most preferably about 25 to about 35 ohm/square inch.

In accordance with the present invention, the samples were investigated by measuring both the real and imaginary part of dielectric permittivities as a function of frequency of applied voltage using a Schlumberger 1260 Impedance gain-phase analyzer (Schlumberger Technologies, England). The relative capacitance is defined by the ratio of the measured capacitances of sample over empty cell. The dielectric relaxation frequencies are obtained as the maximum from the Cole-Cole plots for the imaginary dielectric permittivities versus the real dielectric permittivies. To demonstrate the effectiveness of the present invention, the electrolytic capacitors were constructed according to the method described above. The resulting device provides relative high capacitance and different dielectric relaxation frequencies suitable for different power storage purposes.

### Complex Fluids Based Soft Materials

In the foregoing preliminary study, oil based complex fluids were studied as the capacitor liquid In reference to FIG. 2, the silicon oil fluid as a host material exhibits a low dielectric permittivity (Re[εₒᵢₗ]=2.75) in broad range of frequencies (0.1 Hz-240 kHz). Furthermore, the well-known Cole-Cole (Cole, K. S., Cole, R. H., J. Chem. Phys., 9, 341 (1941)) equation was used to ensure that both the dielectric and phase parameters are rational. The Cole-Cole plot is often used to obtain quick info about the nature of absorption and the susceptibility of the mode. In real systems, when a symmetric distribution of relaxation times exists, the complex permittivity is described by the function:

where ε* is complex permittivity, ω is the relaxation frequency, τ is relaxation time. A number of quantitative information can be collected from this representation. Although it has no frequency axis, because ε′ is monotonously decreasing with increasing frequency, it is known that the higher is the ε′, the lower is the frequency. Since the maximum absorption occurs at the relaxation (or maximum absorption) frequency, it is also known that the top of the semi-circle corresponds to this frequency.

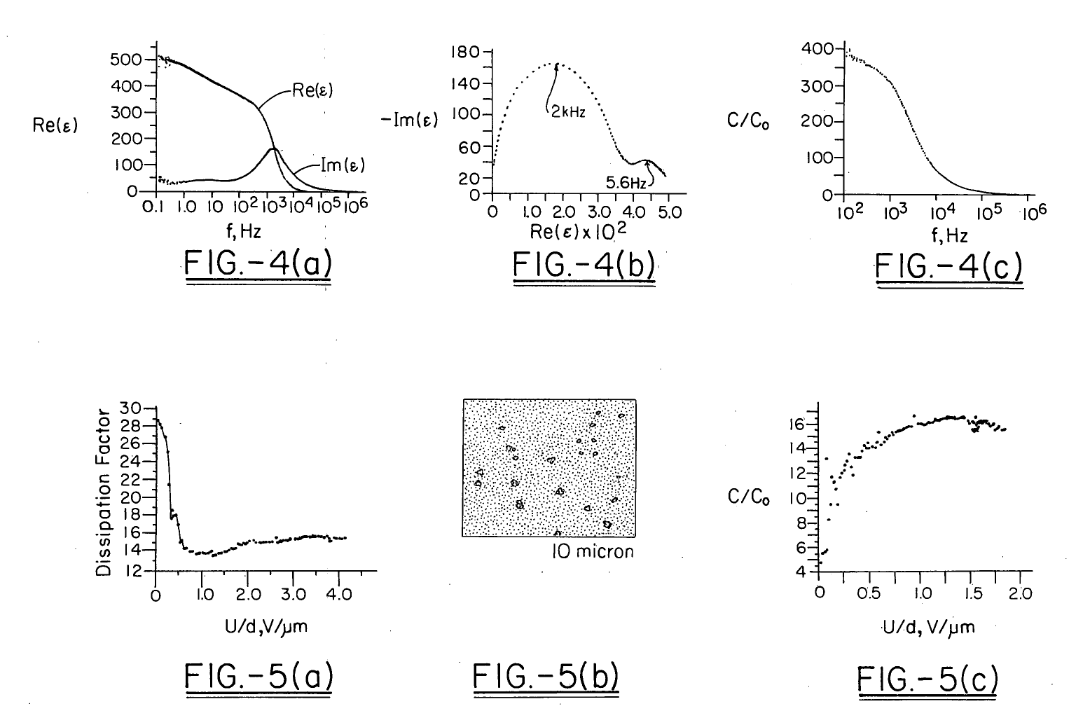

To increase the capacitance, the value of the oil dielectric permittivity was increased by dispersing a guest water solution of the LCLC inside the oil host. The lyotropic liquid crystal of disodium chromoglycate has a disk shape molecular structure. At certain concentration in water solution, the charge distributed and the disk shaped molecules of the lyotropic liquid crystal maintain a nematic phase of columnar aggregates. FIG. 1 is a representation of a liquid crystal fuel cell in accordance with the invention in which FIG. 1(a) illustrates micelle formation at no applied DC field and FIG. 1(b) illustrates the elongation and alignment of the droplets upon the application of a DC field. In this representation, a phase separation of water solution and oil liquid was observed. The dispersed water solution of lyotropic liquid crystal forms the guest droplets inside of oil host. The size of the guest droplets is determined by a surface tension between liquid phases. At no applied DC field (top left photo) the droplet tends to form micelles while upon the application of DC field (bottom left), the shape of droplets tends to be elongated and align in the direction of electric field. It is not yet exploited regarding the ionic and dipole contributions to the high dielectric constant of the complex fluid. In the experiments with the lyotropic liquid crystal additive, an increment up to five orders in dielectric permittivity of the doped mixture (Re[ε_{Oil+cromolyn}]=1.3×10⁵) were measured. The size of the guest droplets affects the relaxation frequency at fᵣ=260 Hz as shown in FIG. 3. The capacitor filled with complex fluid showed an increased capacitance by five orders of magnitude. FIG. 4 shows a three component system with the addition of 0.1% of a 3M Novec® FC4434 water soluble polymeric nonionic fluorinated surfactant into the binary system. The type of surfactant provides very good surface wetting property and is commonly used by coating industry for forming latex. The relative capacitance remains closely to that of the binary systems. In the present experiments, a fluorinate surfactant was used as a third component of the complex mixture to reduce the size of guest droplets. The fluorinated mixture demonstrated a higher relaxation frequency resulting from smaller electrolytic droplets. For example, the relaxation frequency of 2 kHz of the complex fluid doped with the 3M's surfactant FC-4430 was measured as shown in FIG. 4. With fixed LCLC concentration, a significant decrease in dielectric constant with the addition of fluorinated surfactant is clearly seen compared to the system using a block copolymer surfactant. In the meantime, a second relaxation frequency around 5.6 Hz is designated to a larger conglomerate of LCLC droplets. It should be understood that a microemulsion is a very complex dynamical system and it is expected that different types of surfactants will give different size and distribution of dispersed spheres of water droplets in a continuum oil medium. If the droplets retain their discrete character in responding to applied electric field, high density capacitance may be achieved.

The dielectric relaxation frequency of the complex fluids depends not only on the concentration but also the type of surfactant. For example, by replacing surfactant FC4430 with FC4432, a drop in magnitude of about half in magnitude of relative capacitor and a relaxation frequency at 158 Hz is observed. The lower in relative capacitance may be due to the increase in mobility of the micelles. In another case an alkyl polyglucoside nonionic based surfactant from Dow Chemical surfactant yields relative capacitance is fairly high and the relaxation frequency is around 237 Hz. When a block copolymer surfactant of silicon-b-polyethylene oxide (Polysciences, Inc ) is used, the relaxation frequency is found to increase as the increase in surfactant concentration, while the dielectric permittivity decreases as the increase in surfactant concentration because of the reduction in domain size of conductive electrolyte. As the capacitor is charged the capacitance reaches the maximum of 300 nF with the applied voltage of 3V. The may be due to the charged micelles coalesced and the capacitor discharged as the increase in applied voltage. In general, the relative capacitance is still fairly high The capacitance versus applied voltage at 1 kHz is fairly stable as is the dissipation factor versus applied voltage. As the voltage increases, the capacitance is found to be stable with the applied voltage until about 4.5 V/μm, where saturation situation occurs. The capacitance remains constant beyond 3 V/μm The composite of LCLC and photopolymer enables the control of the size of phase-separated droplets by controlling the rate of phase separation by changing conditions of light intensity, monomer/initiator ratio, and temperature of polymerization. Further optimization in composition of composite and process conditions will lead to the development of high density capacitors.

### Polymer Composite Dielectric Films

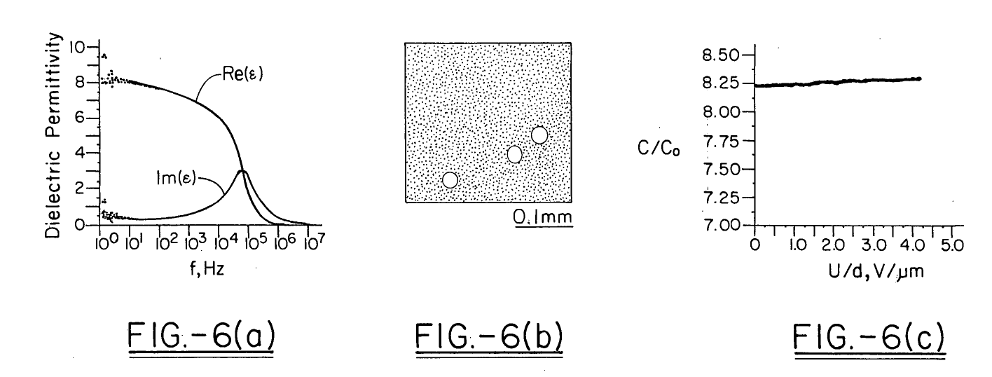

LCLC-based capacitors based on the composite with polymer were also developed without sacrificing the storage/cycle life and power performance at elevated temperature. The LCLC capacitors are suitable for high-current and low-frequency electrical circuits and energy storage. In reference to FIG. 5a, the epoxy-based polymer composite film consisting of epoxy polymer (66.85%), LCLC (33%) and surfactant (0.15%) shows a decrease in dissipation factor with small applied voltage and stabilizes at the further increase of applied voltage up to 4.5 V/□m (a limit of our system) The dissipation factor is defined by the equation of D=½πfCR, where f is the frequency, C is the capacitance, and R is the resistance. The dissipation factor is a measure of electric power lost in all dielectric materials, usually in the form of heat The dissipation factor is expressed as the ratio of the resistive (loss) component of the current to the capacitive component of current, and is equal to the tangent of the loss angle. By confining the LCLC in a few microns size (FIG. 5b) of droplets with the epoxy resin capacitors were obtained with low dissipation factors. The relative capacitance of the composite polymer, LCLC and surfactant as a function of applied voltage at 1 kHz is shown in FIG. 5c. The resulting device provides relatively stable capacitance as the increase of applied voltage.

In reference to FIG. 6, a composite consisting of photo-cured polymer (80%), the LCLC (19.8%) and surfactant (0.2%), the composite material exhibits a very high dielectric relaxation frequency with micron-sized droplets and very good relative capacitance versus applied voltage. The droplets of LCLC in photopolymer matrix are much more uniform and smaller than that of the composite with epoxy.

While in accordance with the patent statutes the best mode and preferred embodiment have been set forth, the scope of the invention is not limited thereto, but rather by the scope of the attached claims.

What is claimed is:

1. A capacitor comprising:
a first electrode and a second electrode defining a gap there between, said gap including a composite electrolyte comprising a lyotropic liquid crystal in a dispersion media.

2. A capacitor as set forth in claim 1, wherein said dispersion media comprises a liquid.

3. A capacitor as set forth in claim 2, wherein the dispersion media comprises an oil.

4. A capacitor as set forth in claim 3, wherein the dispersion media comprises silicon oil.

5. A capacitor as set forth in claim 3, wherein said complex electrolyte further comprises a surfactant.

6. A capacitor as set forth in claim 1, wherein said lytotropic liquid crystal is a chromonic liquid crystal.

7. A capacitor as set forth in claim 4, wherein the liquid crystal is present in the form of micelles within the dispersion media.

8. A capacitor as set forth in claim 7, wherein the type and amount of surfactant is selected to alter the structure of the micelles so as to influence the relaxation frequency of the capacitor.

9. A capacitor as set forth in claim 8, wherein the lyotropic liquid crystal is present in the composite electrolyte in an amount of from about 1 to about 90%.

10. A capacitor as set forth in claim 9, wherein the lyotropic liquid crystal is present in the composite electrolyte in an amount of from about 5 to about 60%.

11. A capacitor as set forth in claim 10, wherein the lyotropic liquid crystal is present in the composite electrolyte in an amount of from about 10 to about 25%.

12. A capacitor as set forth in claim 10, wherein the surfactant is present in the composite electrolyte in an amount of from about 0.05 to about 5% by weight.

13. A capacitor as set forth in claim 1, wherein the dispersion media is a polymer.

14. A capacitor as set forth in claim 13, wherein the polymer is one or more of a chemically polymerized polymer, a photo-polymerized polymer, a thermally polymerized polymer or a polymerized emulsion.

15. A method of making a capacitor having a selected relaxation frequency, comprising the steps of:
a. providing a cell comprising a first electrode having a first surface and a second electrode having a second surface opposite said first surface so as to form a gap;
b. forming a composite electrolyte comprising a lyotropic liquid crystal in a dispersion media; and
c. providing the composite electrolyte in the gap.

16. A method of making a capacitor as set forth in claim 15, wherein the lytotropic liquid is a chromonic liquid.

17. A method of making a capacitor as set forth in claim 16, wherein the complex electrolyte further includes a surfactant.

18. A method of making a capacitor as set forth in claim 15, wherein the dispersion media is a silicon fluid.

19. A method of making a capacitor as set forth in claim 16, wherein the dispersion media is a polymer.

20. A method of making a capacitor as set forth in claim 19, wherein the first and the second electrode each comprise a substrate and the first and second surfaces each include a layer of indium tin oxide.

21. A method of making a capacitor as set forth in claim 20, wherein the first and second layers each include an alignment layer.

22. A method of making a capacitor as set forth in claim 21, wherein the gap further includes spacers.

23. A method of making a capacitor as set forth in claim 17, wherein the surfactant is selected so as to influence the relaxation frequency of the capacitor.

24. A method of making a capacitor as set forth in claim 23, wherein the lyotropic liquid forms micelles within the dispersion media and the surfactant is selected so as to influence the structure of the micelles.

25. A method of making a capacitor as set forth in claim 15, wherein the composite electrolyte further includes one or more additives selected from the group of ferroparticles and nanoparticles.
